(19) United States
(12) Patent Application Publication
(10) Pub. No.: US 2020/0242712 A1
(43) Pub. Date: Jul. 30, 2020

(54) METHOD, APPARATUS AND SYSTEM FOR SELF-SERVICE CONTRACT FOR MOBILE PAYMENTS

(71) Applicant: ALIBABA GROUP HOLDING LIMITED, Grand Cayman (KY)

(72) Inventor: Chuan LU, HANGZHOU (CN)

(21) Appl. No.: 16/830,057

(22) Filed: Mar. 25, 2020

Related U.S. Application Data
(63) Continuation of application No. PCT/CN2020/070941, filed on Jan. 8, 2020.

(30) Foreign Application Priority Data
May 14, 2019 (CN) 201910400049.9

(51) Int. Cl. G06Q 50/18; G06Q 20/32; G06Q 20/40; G06Q 10/10; G06Q 40/02; G06Q 20/34; G06Q 20/10; G06Q 20/18; G06K 7/14; G06K 7/10; G06F 3/0488

(52) U.S. Cl. CPC G06Q 50/18; G06Q 20/3276; G06Q 20/3223; G06Q 20/4014; G06Q 10/10; G06Q 40/02; G06F 3/04883; G06Q 20/108; G06Q 20/18; G06K 7/1413; G06K 7/1417; G06K 7/10366; G06Q 20/341

(57) ABSTRACT

A contract signing method for mobile payments, includes: scanning an identification code generated by a payment application; transmitting a result of the scanning to a payment server for verification; in response to receiving a successful verification result from the payment server, prompting a user to input personal identification information; receiving the personal identification information inputted by the user, and transmitting the personal identification information to a service provider server for verification; in response to receiving a successful verification result from the service provider server, prompting the user to provide a signed authorization for a contract; receiving the signed authorization from the user, and sending a contract signing request to the payment server by using the signed authorization; and receiving a notification indicating whether the contract signing succeeds from the payment server.

### CROSS-REFERENCE TO RELATED APPLICATIONS

This application is a continuation application of International Patent Application No. PCT/CN2020/070941, filed on Jan. 8, 2020, which claims priority to and benefits of the Chinese Patent Application No. 201910400049.9, filed on May 14, 2019. The contents of the above-referenced applications are incorporated herein by reference in their entirety.

### TECHNICAL FIELD

This disclosure relates to mobile payments, and in particular, to self-service contract signing for mobile payments.

### BACKGROUND

Various representative payment tools in the era of mobile payments (such as Tencent's WeChat Pay and Apple's Apple Pay, etc.) provide many types of payment methods. For example, in fund withholding, a fund withholding agreement is signed between a user and a service provider on an H5 page. Afterwards, in some circumstances including a network not unavailable for the user and based on actual purchasing amount of the user, the service provider can initiate a deduction using deduction interfaces provided by these mobile payment tools to complete payment. The user learns the deduction from notifications/bills or the like from these mobile payment tools, which greatly facilitate the user's purchasing in certain scenarios.

### SUMMARY OF THE INVENTION

According to one embodiment of the specification, a contract signing terminal for mobile payments may comprise: a scanning apparatus configured to scan an identification code generated by a payment application, wherein the scanning apparatus comprises a camera; a touch-sensitive display screen configured to display a prompt to a user and receiving a touch input of the user, wherein the prompt displays a message for prompting the user to perform one or more following operations: placing the identification code within a scanning area of the scanning apparatus, inputting personal identification information, and creating a signed authorization; a communication apparatus configured to communicate with a payment server and a service provider server; and a processing apparatus, configured to: transmit to the payment server a result from the scanning apparatus via the communication apparatus for verification; prompt, in response to a first successful verification result received by the communication apparatus from the payment server, the user to input the personal identification information by using the touch-sensitive display screen; receive the personal identification information inputted by the user on the touch-sensitive display screen, and transmit the personal identification information to the service provider server via the communication apparatus for verification; prompt, in response to a second successful verification result received by the communication apparatus from the service provider server, the user to provide a signed authorization for a contract by using the touch-sensitive display screen; receive the signed authorization from the user via the touch-sensitive display screen, and send a contract signing request to the payment server via the communication apparatus by using the signed authorization; and receive, from the payment server, a notification indicating whether the contract signing succeeds via the communication apparatus.

According to one embodiment of this disclosure, the identification code is a two-dimensional code, a bar code, or an electronic tag.

In some embodiments, the touch-sensitive display screen is further configured to display the verification indicating a successful contract signing.

In some embodiments, the signed authorization is a handwritten signature of the user.

In some embodiments, the terminal for mobile payments further comprises a stylus pen, and the handwritten signature is written on the touch-sensitive display screen by the user using the stylus pen.

In some embodiments, the contract signing request is a request for withholding funds.

In some embodiments, the terminal for mobile payments further comprises an input apparatus configured to receive a user input, and the user input comprises personal identification information and a signed authorization from the user for contract signing.

In some embodiments, the input apparatus comprises a card reader, and the personal identification information is obtained by using the card reader to read a smart card provided to the user by a service provider associated with the service provider server.

In some embodiments, a contract signing method for mobile payments is provided, comprising: scanning an identification code generated by a payment application; transmitting a result of the scanning to a payment server for verification; prompting, in response to receiving a first successful verification result from the payment server, a user to input personal identification information; receiving the personal identification information inputted by the user, and transmitting the personal identification information to a service provider server for verification; prompting, in response to receiving a second successful verification result from the service provider server, the user to provide a signed authorization for a contract; receiving the signed authorization from the user, and sending a contract signing request to the payment server by using the signed authorization; and receiving, from the payment server, a notification indicating whether the contract signing succeeds.

In some embodiments, the contract is a contract for withholding funds, and the contract signing request is a request for the withholding funds.

In some embodiments, if the verification for the result of the scanning fails, the method further comprises prompting the user to re-present the identification code generated by the payment application.

In some embodiments, when the user is prompted to re-present the identification code generated by the payment application, the method may further comprise: displaying on a display screen a picture showing an operation process of the identification code generated by the payment application to assist the user.

In some embodiments, the prompting the user to input personal identification information comprises providing various options to the user for inputting the personal identification information, and the various options at least comprise inputting from a keyboard, or inputting by a card reader reading a card.

In some embodiments, the signed authorization is a handwritten signature of the user. The handwritten signature may be inputted on a touch-sensitive display by the user using a stylus pen or a finger.

In some embodiments, before the user is allowed to create a handwritten signature, the method may further comprise: showing that a preset time is reached for the contract.

In some embodiments, the method further comprises: incrementing, in response to receiving a failed verification result from the service provider server, a first counter by one, and comparing a count of the first counter with a first threshold value; returning, when the count is greater than the first threshold value, to scanning the identification code generated by a payment application; and prompting, when the count is not greater than the first threshold value, the user to input personal identification information again.

According to still another embodiment of this disclosure, the method further comprises: incrementing, in response to receiving a failed verification result from the payment server, a second counter by one, and comparing a count of the second counter with a second threshold value; returning, when the count is greater than the second threshold value, to scan an identification code generated by a payment application; and prompting, when the count is not greater than the second threshold value, a user to input a signed authorization again.

In some embodiments, a contract signing method for mobile payments is provided, comprising: generating and providing, via a payment application, a payment identification code; scanning, by the self-service contract signing terminal for mobile payments, the payment identification code and transmitting a result of the scanning to a payment server; in response to receiving the result of the scanning, verifying, by the payment server, a relevant payment account and transmitting a verification result of the relevant payment account to the terminal for payments; when the payment account is successfully verified, prompting, by the terminal for mobile payments, a user to input personal identification information; transmitting, by the terminal for mobile payments, the inputted personal identification information to a service provider server for verification; in response to receiving the personal identification information, verifying, by the service provider server, validity of the personal identification information and transmitting a verification result of the validity of the personal identification to the terminal for mobile payments; when the personal identification information is successfully verified, prompting, by the terminal for mobile payments, the user to provide a signed authorization for a contract; after the signed authorization from the user is received, sending, by the terminal for mobile payments, a contract signing request to the payment server by using the signed authorization; processing, by the payment server, the contract signing request to determine whether the contract signing request is allowed; and transmitting a result of the contract signing to the terminal for mobile payments and the service provider server.

In some embodiments, the personal identification information is inputted as follows: the user places a smart card in a reading area of a card reader of the terminal for mobile payments, to enable the terminal for mobile payments to read card information, thereby obtaining the personal identification information.

In some embodiments, the contract signing request is a request for withholding funds.

In some embodiments, a contract signing system for mobile payments a processor, and a memory, configured to store computer executable instructions, which, when executed, cause the processor to perform operations including: scanning an identification code generated by a payment application; transmitting a result of the scanning to a payment server for verification; prompting, in response to receiving a first successful verification result from the payment server, a user to input personal identification information; receiving the personal identification information inputted by the user, and transmitting the personal identification information to a service provider server for verification; prompting, in response to receiving a second successful verification result from the service provider server, the user to provide a signed authorization for a contract; receiving the signed authorization from the user, and sending a contract signing request to the payment server by using the signed authorization; and receiving, from the payment server, a notification indicating whether the contract signing succeeds.

Each of embodiments comprise a method, apparatus, system, computer program product, and processing system as basically described in this description with reference to the accompanying drawings and as illustrated in the accompanying drawings.

The foregoing content has generally depicted exemplary features and technical advantages of this specification, to facilitate a better understanding of the detailed descriptions below. Additional features and advantages are described hereinafter. The disclosed concepts and examples can be easily used as a foundation for modifying or designing other structures for achieving the same objectives as this disclosure. Such equivalent structures do not go beyond the scope of the attached claims. The organization and operation method of the characteristics of the concepts disclosed in this description and related advantages will be better understood considering the following descriptions with reference to the accompanying drawings. Each accompanying drawing is intended for illustrative and descriptive purposes rather than defining a limitation on the claims.

### BRIEF DESCRIPTION OF THE DRAWINGS

To facilitate a detailed understanding of the manners used by the above-described features in this disclosure, the foregoing summary can be described in detail with reference to different embodiments, and some embodiments are illustrated in the accompanying drawings. The accompanying drawings may not be considered as limiting the scope of this specification; this description may thus allow other equivalent effective embodiments. Same reference numerals in different accompanying drawings may identify the same or similar elements.

FIG. 1 shows a schematic diagram of an exemplary self-service contract signing terminal for mobile payments according to some embodiments of this specification.

FIGS. 2A to 2C show flow charts of an exemplary self-service contract signing method for mobile payments implemented by a self-service contract signing terminal for mobile payments according to some embodiments of this specification;

FIG. 3 shows a schematic diagram of an operation process of an exemplary self-service contract signing system for mobile payments according to embodiments of this specification; and

FIG. 4 shows a schematic diagram of an exemplary self-service contract signing system for mobile payments according to some embodiments of this specification.

### DETAILED DESCRIPTION OF EMBODIMENTS

The following detailed descriptions given with reference to the accompanying drawings are intended for describing various embodiments and are not meant to represent exclusive embodiments for implementing the concepts described in this specification. These detailed descriptions include details to facilitate a thorough understanding of various concepts. However, it is obvious to a person of ordinary skill in the art that these concepts can still be implemented without these details.

As used herein, “mobile payment” may be a payment, made by a mobile device (such as a smart mobile phone and a tablet device) by performing a scanning via a mobile payment application (such as WeChat Pay and Apple Pay) or by using an NFC technology.

As used herein, “contract signing for withholding funds” also known as “contract signing for deduction”, may be defined as signing an agreement with a payment institution to carry out fund withholding with regard to a service provider, a service, a software application and the like bound with the agreement, thereby enabling an automatic fee deduction.

In limited network resources, there are problems in contract signing for mobile payments (for example, contract signing for withholding funds). For example, due to a limited bandwidth, if many users initiate contract signing at the same time (for example, contract signing for withholding funds), the bandwidth allocated to each user is small, resulting in an extremely low success rate in the users' contract signing. This also brings users a rather poor user experience. For example, according to the statistics, in a large cruise ship with a limited network bandwidth, a success rate of contract signing for a cross-border mobile payment withholding is about 20%, and the main reason for failure of the contract signing is due to the limited network resources.

Therefore, this specification provides a self-service contract signing terminal for mobile payments. A contract signing request is initiated on behalf of a user by using the self-service contract signing terminal for mobile payments. In this way, network bandwidth resources can be more effectively used, the success rate of the contract signing can be increased, and accordingly, user experience is improved. For example, the self-service contract signing terminal for mobile payments can allocate a fixed proportion of network bandwidth resources required to ensure a successful contract signing, thereby guaranteeing a success rate of the contract signing.

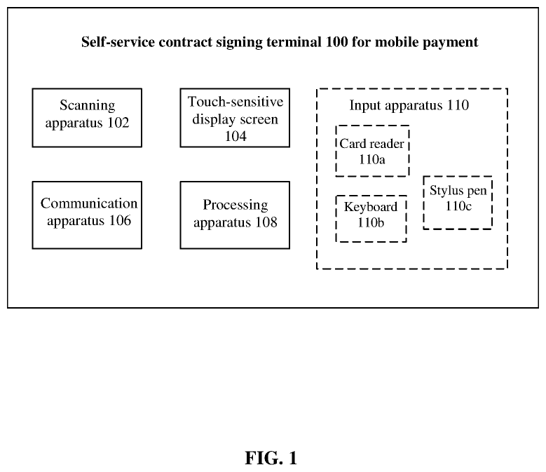

FIG. 1 shows a schematic diagram of a self-service contract signing terminal 100 for mobile payments according to some embodiments of this specification. In some embodiments, the self-service contract signing terminal 100 for mobile payments shown in FIG. 1 is configured to initiate and send a contract signing request on behalf of a user to a mobile payment server, which may effectively prevent many users from competing with one another for limited network bandwidth resources, thereby improving the success rate of the contract signing and user experience.

As shown in FIG. 1, the self-service contract signing terminal 100 for mobile payments may comprise a scanning apparatus 102, a touch-sensitive display screen 104, a communication apparatus 106, and a processing apparatus 108. In some embodiments, the scanning apparatus 102 of the self-service contract signing terminal 100 for mobile payments is configured to scan an identification code generated by a mobile payment application (such as WeChat Pay and Apple Pay). For example, the scanning apparatus 102 comprises a camera for scanning the identification code (e.g., a two-dimensional code). In one example, the identification code may be any of a two-dimensional code, a bar code or an electronic tag.

In some embodiments, the touch-sensitive display screen 104 of the self-service contract signing terminal 100 for mobile payments is configured to display various prompts to the user and receive touch inputs from the user. For example, the touch-sensitive display screen 104 may display a prompt message for prompting the user to perform one or a plurality of the following operations: placing the identification code within a scanning area of the scanning apparatus, inputting personal identification information, and creating a signed authorization. For example, the touch-sensitive display screen 104 may display a prompt message for prompting the user to present a two-dimensional code generated by WeChat Pay under the camera of the scanning apparatus. In one example, when the touch-sensitive display screen 104 prompts the user to input personal identification information and/or a signed authorization, the touch-sensitive display screen 104 may further display a virtual keyboard, a handwriting area, or the like that allows the user to input such information.

In some embodiments, as a supplement to displaying the prompt, the self-service contract signing terminal 100 for mobile payments may further optionally comprise a speaker (not shown in FIG. 1) configured to send a voice prompt to a user. For example, when the solution is applied in a large cruise ship, the speaker may send out a voice prompt, such as “please input your room number” and “please present a two-dimensional code for your WeChat payment account.”

In some embodiments, the communication apparatus 106 is configured to communicate with a mobile payment server and a service provider server, to transmit user inputs received from the user and receive responses from the mobile payment server and the service provider server. In some embodiments, the processing apparatus 108 is provided with a corresponding processing function. For example, the processing apparatus 108 can be a processor. The processing apparatus 108 is configured to interact with the scanning apparatus 102, the touch-sensitive display screen 104 and the communication apparatus 106 to process, display, receive or send various information.

For example, in the above scenario of the large cruise ship, after the scanning apparatus 102 scans the identification code of the WeChat payment account provided by the user, the processing apparatus 108 may be configured to transmit a result of the scanning via the communication apparatus 106 to the mobile payment server for verification (for example, verifying account validity and/or identity), and then receive a verification result from the mobile payment server via the communication apparatus 106. After the verification succeeds (for example, in responding to the communication apparatus 106 receiving a first successful verification result from the mobile payment server), the processing apparatus 108 may be further configured to prompt the user, via the touch-sensitive display screen 104, to input the personal identification information, such as displaying a prompt message prompting the user to input the personal identification information on the touch-sensitive touch display 104. After the touch-sensitive display screen 104 receives the personal identification information inputted by the user, the processing apparatus 108 may be further configured to transmit the received personal identification information to the service provider server via the communication apparatus 106 for verification, and receive a verification result. In addition, after the communication apparatus 106 receives a second successful verification result from the service provider server, the processing apparatus 108 may be further configured to prompt the user, via the touch-sensitive display screen 104, to provide a signed authorization for a contract (for example, contract signing for withholding funds). After the touch-sensitive display screen 104 receives the signed authorization from the user, the processing apparatus 108 may be further configured to send to the mobile payment server a contract signing request by using the received signed authorization of the user via the communication apparatus 106, and receive a verification indicating whether the contract signing succeeds.

In some embodiments, as a supplement or alternative to an input function of the touch-sensitive display screen 104, the self-service contract signing terminal 100 for mobile payments may further comprise an input apparatus 110. For example, the input apparatus 110 may comprise one or a plurality of a card reader 110a, a keyboard 110b, a stylus pen 110c, and the like. The input apparatus 110 may be configured by a user to input various information, such as personal identification information, a user's signed authorization of contract signing, etc. The user may place a smart card allocated by a corresponding service provider in a reading area of the card reader 110a to input the user's personal identification information. For example, in a large cruise ship, each user has a room card of a corresponding room allocated by a cruise ship company. The user may place the room card in the reading area of the card reader 110a to input the personal identification information (such as a room number and the like) thereof.

In some embodiments, the user can input the personal identification information, such as an identification card number and a room number thereof by using the keyboard 110b. In some embodiments, the user can input various information using the stylus pen 110c to write on a handwriting area of the touch-sensitive display screen 104 and to create a handwritten signature. In this example, a signed authorization is the handwritten signature of the user. In another example, the user may alternatively use the stylus pen 110c to touch a virtual keypad area, an interface element, or the like on the touch-sensitive display screen 104 to provide an input.

In some embodiments, the touch-sensitive display screen 104 further may display a verification indicating whether the contract signing succeeds. For example, when the WeChat Pay application is used on a large cruise ship, if the signed authorization of the user is verified, the self-service contract signing terminal 100 for mobile payments receives a successful verification result from the mobile payment server, and thus the touch-sensitive display screen 104 can display a verification of “successful contract signing” to the user. In some embodiments, the self-service contract signing terminal 100 for mobile payments may comprise a speaker (not shown in FIG. 1) for playing a verification. In this example, as an alternative or supplement to displaying the notification on the touch-sensitive display screen 104, the speaker may alternatively be configured to play a corresponding notification, such as “congratulations, the contract signing succeeds.”

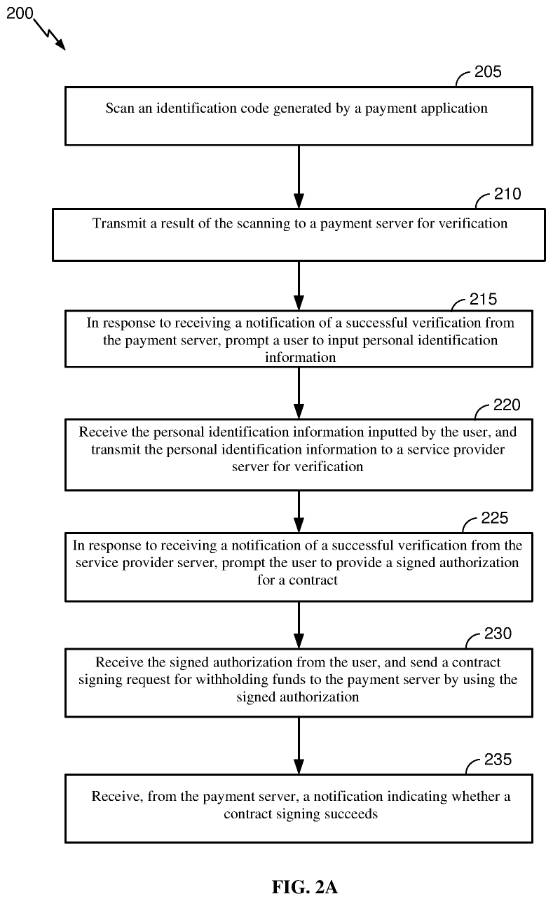

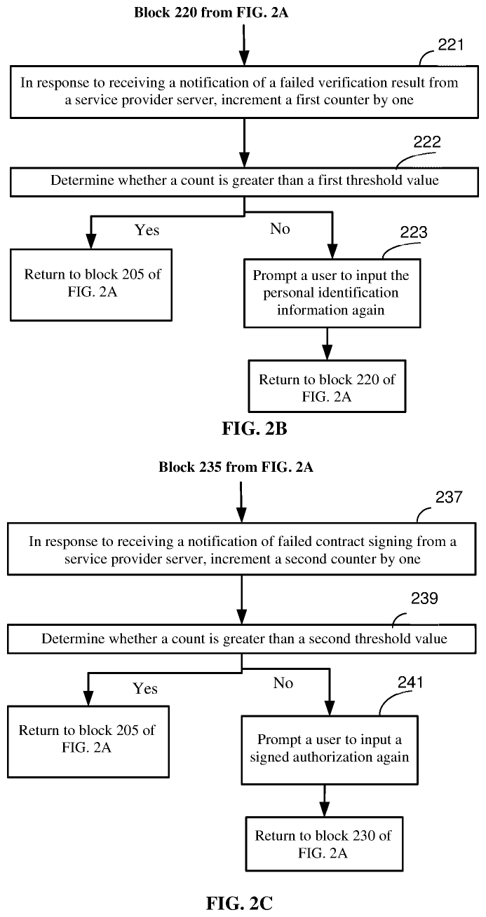

FIG. 2A shows a flow chart of an exemplary self-service contract signing method for mobile payments 200 implemented by a self-service contract signing terminal for mobile payments according to some embodiments of this specification. In some embodiments, the method 200 may be implemented by the self-service contract signing terminal 100 for mobile payments shown in FIG. 1.

As shown in FIG. 2A, the method 200 may comprise, in block 205, scanning an identification code generated by a mobile payment application of a user. In some embodiments, a touch-sensitive display screen 104 can display a prompt, to prompt the user to generate an identification code by using the mobile payment application thereof and to present the generated identification code under a scanning apparatus 102 (such as a camera. Afterwards, after the user correctly generates and presents the identification code, the scanning apparatus 102 can scan the identification code.

For example, when the WeChat Pay application is used on a large cruise ship, the self-service contract signing terminal 100 for mobile payments may prompt the user to login to the user's WeChat payment account, generate an account identification code (such as a two-dimensional code, a bar code, and the like), and place the generated identification code under the scanning apparatus (such as a camera). The scanning apparatus 102 can then scan the identification code that the user presents.

The method 200 may further comprise, in block 210, transmitting a result of the scanning to a mobile payment server for verification of account validity. Following the above embodiment, a communication apparatus 106 of the self-service contract signing terminal 100 for mobile payments can transmit the result of the scanning to the corresponding mobile payment server, such that the mobile payment server verifies validity of a corresponding user account and the identity of the user.

In some embodiments, if the user mistakenly presents an identification code generated by another application (such as a social network application or a game application) under the scanning apparatus 102, the above-described verification fails; and the mobile payment server notifies the self-service contract signing terminal 100 for mobile payments that the verification fails. In this case, the self-service contract signing terminal 100 for mobile payments can prompt the user again for providing a correct identification code. In some embodiments, the self-service contract signing terminal 100 for mobile payments may provide the user with the reason of the failed verification result (for example, the provided identification code is not generated by an expected mobile payment application such as WeChat Pay), to guide the user to take a correct action. The self-service contract signing terminal 100 for mobile payments may use a voice prompt, display a text prompt on a display screen, display an operation process screen, or the like to guide the user.

For example, in the above-described scenario of the large cruise ship, if the user mistakenly places an identification code generated by a certain game application under the scanning apparatus 102, the verification fails. In response to such failed verification result, the self-service contract signing terminal 100 for mobile payments can send a voice prompt: “Incorrect identification code. Please provide an identification code of your WeChat payment account.” As an alternative or supplement, the self-service contract signing terminal 100 for mobile payments may also display, on the touch-sensitive display screen 104, a picture showing a process of how to present the identification code generated by WeChat Pay, to further guide the user.

Referring now to FIG. 2A, the method 200 may further comprise, in block 215, in response to receiving a successful verification result from the mobile payment server, prompting the user to input personal identification information. In one embodiment, the self-service contract signing terminal 100 for mobile payments receives a verification result from the mobile payment server. If the verification succeeds, the self-service contract signing terminal 100 for mobile payments prompts the user to input the personal identification information. For example, the self-service contract signing terminal 100 for mobile payments may prompt the user to choose a method for inputting the personal identification information using a room card, or manually inputting the personal identification information (such as an identification card number, a room number, a phone number, and the like).

In the above scenario of the large cruise ship, the user usually has an associated smart room card. If the user chooses to input the personal identification information by using the room card, the self-service contract signing terminal 100 for mobile payments may prompt the user to place the room card near a card reader or swipe the room card on the card reader, to read the user's personal identification information.

In some embodiments, the user may choose to manually input the personal identification information (for example, when the room card is not with the user). In such situations, in response to the user's choice, the self-service contract signing terminal 100 for mobile payments may display a prompt on a display screen thereof, to allow the user to provide the personal identification information by using an input apparatus 110, a physical or virtual keyboard. For example, in the scenario of a large cruise ship, the self-service contract signing terminal 100 for mobile payments may prompt the user to input the personal identification information, such as a cruise ship room number, an identification card number, a visa number, a phone number, and the like for verification.

In block 220 in FIG. 2A, the method 200 may comprise receiving the personal identification information inputted by the user, and transmitting the personal identification information to a service provider server for verification. For example, in the above exemplary scenario of the large cruise ship, the self-service contract signing terminal 100 for mobile payments may read information of the room card of the user via the card reader 110a, and transmit the information to the associated service provider server, or may provide the identification information inputted by the user via the input apparatus such as a keyboard to the associated service provider server.

The method 200 may further comprise, in block 225, in response to receiving a successful verification result from the service provider server, prompting the user to provide a signed authorization for a contract (for example, contract signing for withholding funds). For example, the self-service contract signing terminal 100 for mobile payments may display the contract on the touch-sensitive display screen 104 thereof for reviewing and signing by the user. The user may provide a signature in a signature area on the touch-sensitive display screen 104 for authorization using a finger or a stylus pen. In one embodiment, before the user can create a signature, the self-service contract signing terminal 100 for mobile payments may require the user to fully understand the contract. For example, before allowing the user to sign, the self-service contract signing terminal 100 for mobile payments may display that a preset time (e.g., 20 seconds or 30 seconds) is reached for the contract. Alternatively, the self-service contract signing terminal 100 for mobile payments may require the user to select a check box of accepting the contract before the signing can be performed.

In some embodiments, if a failed verification result from the service provider server is received (e.g., the failed verification result is received due to incorrect room card information), the self-service contract signing terminal 100 for mobile payments may prompt the user to provide the personal identification information again (e.g., by swiping a room card again) and repeat the operation in block 220. In this embodiment, such repetitive operation may have an associated threshold number of times (e.g., 3 times or 5 times); in other words, after the operation is repeated for the threshold number of times, the self-service contract signing terminal 100 for mobile payments can return to block 205 to restart, which is shown in detail in FIG. 2B. FIG. 2B illustrates an operation process after a failed verification result is received from the service provider server.

As shown in FIG. 2B, in block 221, in response to receiving a failed verification result from the service provider server, a first counter is incremented by one. For example, an initial value of the first counter is set as zero, and each time the verification fails, one count is added. Afterwards, in block 222, the self-service contract signing terminal 100 for mobile payments determines whether the count of the first counter is greater than a threshold value. If so, the self-service contract signing terminal 100 for mobile payments returns to block 205 of FIG. 2A to prompt and wait to scan the identification code provided by the user. If not, in block 223, the self-service contract signing terminal 100 for mobile payments prompts the user to input the personal identification information again, and returns to block 220 of FIG. 2A to receive the information.

Referring to FIG. 2A, the method 200 may further comprise, in block 230, receiving the signed authorization from the user, and sending a contract signing request for withholding funds to the mobile payment server by using the signed authorization. For example, in the above exemplary scenario of the large cruise ship, after receiving the signed authorization from the user (for example, the signature is the user's handwritten signature using a finger or a stylus pen), the self-service contract signing terminal 100 for mobile payments sends a contract signing request for withholding funds to a WeChat server by using the signed authorization and other information (such as a WeChat payment account scanned in the above block 205).

The method 200 may further comprise, in block 235, receiving, from the mobile payment server, a notification indicating whether the contract signing succeeds. For example, in the above exemplary scenario of the large cruise ship, if the mobile payment server determines that the contract signing request for withholding funds is allowed, the mobile payment server will send a successful verification result of the contract signing to the self-service contract signing terminal 100 for mobile payments. Afterwards, the self-service contract signing terminal 100 for mobile payments may display the verification on the touch-sensitive display screen 104 thereof. For example, when the self-service contract signing terminal 100 for mobile payments comprises a speaker, the successful verification result of a contract signing may be played through the speaker.

As another example, if the mobile payment server determines that the contact signing request for withholding funds is not allowed because the user's signature is not accepted (for example, the signature is not a signature of the user holding a WeChat payment account), the mobile payment server will send a notification of a failed contract signing to the self-service contract signing terminal 100 for mobile payments. The self-service contract signing terminal 100 for mobile payments may display the notification of the failed contract signing and may optionally display the reason for the failed contract signing, such as an error in signature. In such situations, the self-service contract signing terminal 100 for mobile payments may further prompt the user to further input a handwritten signature and continue the above-described operations in blocks 230 to 235. For example, the self-service contract signing terminal 100 for mobile payments may further set a threshold number of times for the failed contract signing (e.g., 3 times or 5 times). If the number of times of the failed contract signing exceeds the threshold number of times, the mobile payment self-signing terminal 100 for mobile payments can terminate the current self-service contract signing and return to block 205 to restart a self-service contract signing process, which shows in detail in FIG. 2C. in which an operation process after the notification of the failed contract signing is received from the mobile payment server is shown.

Referring now to FIG. 2C, FIG. 2C shows an operation process after the notification of the failed contract signing is received from the mobile payment server. In block 237, in response to receiving, from the service provider server, the notification of the failed contract signing, a second counter is incremented by one. For example, an initial value of the second counter is set as zero, and each time the contract signing fails, one count is added. Afterwards, in block 239, the self-service contract signing terminal 100 for mobile payments determines whether the count of the second counter is greater than a second threshold. If so, the self-service contract signing terminal 100 for mobile payments returns to block 205 of FIG. 2A to prompt and wait to scan the identification code provided by the user. If not, in block 241, the self-service contract signing terminal 100 for mobile payments prompts the user to input the signed authorization again and returns to block 230 of FIG. 2A to receive the signature.

Those skilled in the art can understand that “the first threshold value” and “the second threshold value” only represent two separate threshold values which may or may not be the same.

In addition, according to one embodiment of this disclosure, after receiving the notification of a successful contract signing from the mobile payment server, the self-service contract signing terminal 100 for mobile payments clears the first counter and the second counter.

In addition, those skilled in the art can understand that although this disclosure only provides the operation processes for the cases where the verification for the personal identification information of the user at the service provider server fails and the verification for the signed authorization at the mobile payment server fails, the process where the verification of the identification code at the mobile payment server fails may alternatively be handled in a similar manner. For example, if a notification indicating the failed verification result of the identification code from the mobile payment server is received, the self-service contract signing terminal 100 for mobile payments may alternatively increment a corresponding third counter by one, and prompt the user to change a mobile payment identification code or ask for help from staff of the service provider and the like, after the count of the third counter exceeds a threshold value.

In another alternative embodiment, the counter may be omitted, such that the self-service contract signing terminal for mobile payments returns to rescan the mobile payment identification code whenever a notification of a verification or a failed contract signing is received.

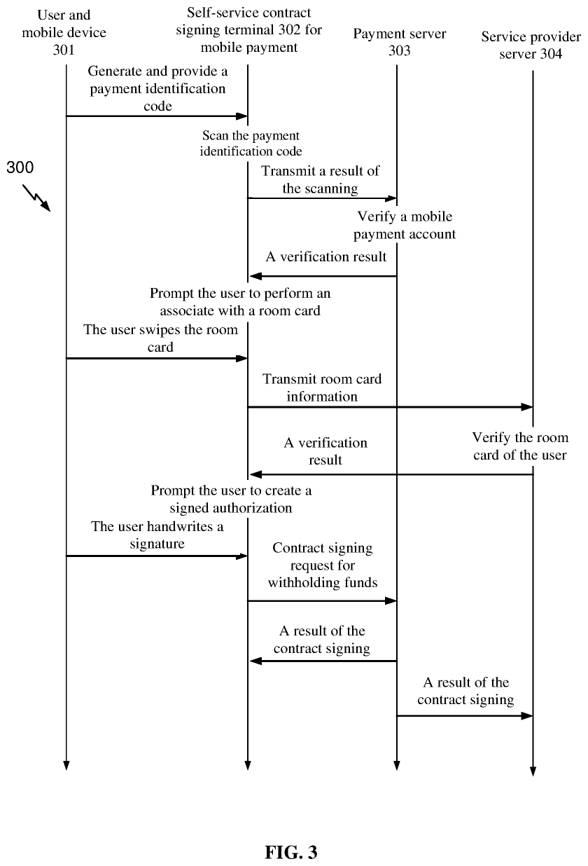

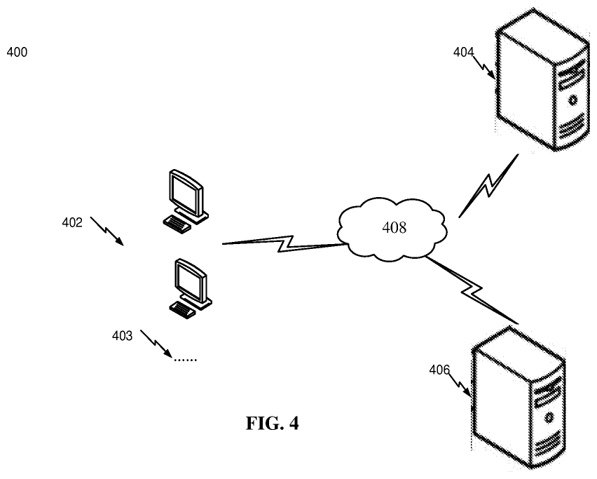

Referring now to FIG. 3, FIG. 3 shows a schematic diagram of an operation process 300 of an exemplary self-service contract signing system for mobile payments according to all embodiments of this specification. The operation process shown in FIG. 3 is described in combination with the above exemplary scenario of the large cruise ship. However, those skilled in the art can understand that all operations in FIG. 3 may be operations in any of the alternative embodiments described above in combination with FIG. 1 and FIG. 2. For example, swiping a room card by a user can be changed to inputting a room number, a card number, an identification card number, a phone number, etc. by the user using a virtual or physical keyboard.

As shown in FIG. 3, the process 300 starts when a user uses a mobile device thereof to generate and provide a mobile payment identification code. In some embodiments, according to a prompt of a self-service contract signing terminal 302 for mobile payments, the user can use a mobile payment application installed on the mobile device thereof to generate the mobile payment identification code and provide the mobile payment identification code to the self-service contract signing terminal for mobile payments for scanning. For example, the user may enable the WeChat Pay application on his mobile device, generate a corresponding two-dimensional code, and place the two-dimensional code under a scanning apparatus (such as a camera) of the self-service contract signing terminal for mobile payments for scanning.

The self-service contract signing terminal 302 for mobile payments then scans the two-dimensional code provided by the user and transmits a result of the scanning to a mobile payment server 303. The mobile payment server 303 receives the result of the scanning and verifies the user's mobile payment account. For example, the mobile payment server 303 may verify validity of the corresponding mobile payment account.

Afterwards, the mobile payment server 303 may return a verification result of the validity of the personal identification to the self-service contract signing terminal 302 for mobile payments. When receiving a successful verification result, the self-service contract signing terminal 302 for mobile payments may prompt the user to perform an association with a room card action. The “association with a room card” action means that the user is prompted to place a smart room card allocated by the large cruise ship in a reading area of a card reader of the terminal to obtain card information, thereby associating the room card with a mobile payment account.

After obtaining the above-described prompt, the user can swipe the room card. The self-service contract signing terminal 302 for mobile payments then transmits the obtained room card information to a service provider server 304 (such as a server associated with the large cruise ship) for verification. The service provider server 304 then transmits a verification result of the validity of the personal identification to the self-service contract signing terminal 302 for mobile payments.

If the verification succeeds, the self-service contract signing terminal 302 for mobile payments may use a touch-sensitive display screen, a speaker, or the like thereof to prompt the user to create a signed authorization. After receiving the user's signature (such as the user's handwritten signature), the self-service contract signing terminal 302 for mobile payments sends a contract signing request for withholding funds to the mobile payment server 303 by using the signature. The mobile payment server 303 processes the contract signing request for withholding funds to determine whether to allow the contract signing request for the withholding funds. For example, the mobile payment server 303 may compare a user's signed authorization with the user's pre-stored signature or with the user's real name to determine whether to allow the contract signing request for withholding funds. The mobile payment server 303 may compare a handwriting of the user's signature with a pre-stored handwriting signature of the user to determine whether the signatures are from the same user.

Alternatively, the mobile payment server 303 may use a character recognition technology such as OCR to identify all characters of the user's signature and compares the characters with pre-stored information such as a user's name to verify the user. If the signature of the user is determined to be authentic, the mobile payment server 303 determines that the contract signing succeeds and then sends a notification of a successful contract signing to the self-service contract signing terminal 302 for mobile payments and the service provider server 304.

In some embodiments, the mobile payment server 303 may further send the notification of a successful contract signing to the mobile device of the user. For example, the mobile payment server 303 may send the notification of a successful contract signing to the mobile device of the user using a short message, an e-mail, and so on.

Reference is now made to FIG. 4. FIG. 4 shows a schematic diagram of an exemplary self-service contract signing system 400 for mobile payments according to some embodiments of this specification. As shown in FIG. 4, the self-service contract signing system 400 for mobile payments comprises one or a plurality of self-service contract signing terminals 402 for mobile payments (in one example, the terminal may be the self-service contract signing terminal 100 for mobile payments), a mobile payment server 404, and a service provider server 406.

In some embodiments, the self-service contract signing terminal 402 for mobile payments, the mobile payment server 404, and the service provider server 406 can be operated according to various processes described in combination with FIG. 1 to FIG. 3 above to achieve signing for withholding funds for mobile payments. In some embodiments, the one or plurality of self-service contract signing terminals 402 for mobile payments collectively communicate with the mobile payment server via a limited network bandwidth, where the limited network bandwidth is evenly distributed among the self-service contract signing terminals for mobile payments. Although only two self-service contract signing terminals for mobile payments are shown in FIG. 4 for simplicity, ellipsis 403 indicates that the self-service contract signing system 400 for mobile payments may comprise more self-service contract signing terminals for mobile payments or only one self-service contract signing terminal for mobile payments.

The foregoing implementation manners include reference to the accompanying drawings which constitute a part of the implementation manners. The accompanying drawings show feasible embodiments through description. These embodiments are also referred to as “examples” herein. Such examples may comprise elements besides the illustrated or described elements. However, examples comprising the illustrated or described elements are also contemplated. Moreover, further contemplated are examples using any combination or permutation of those elements shown or described, either with respect to an example (or one or more embodiments thereof), or with respect to other examples (or one or more embodiments thereof) shown or described herein.

In the attached claims, the terms “comprise” and “include” are non-exhaustive. In other words, systems, devices, products or processes of elements other than those listed after such terms in a claim are also considered as falling within the scope of that claim. In addition, in the attached claims, terms such as “first”, “second”, and “third” are only used for marking, and are not intended for representing a numerical order of their objects.

Moreover, the sequences of the operations illustrated in this description are examples. In some embodiments, the operations may be performed in a sequence different from those shown in the accompanying drawings, and the operations may be combined into one operation or split into more operations.

The foregoing descriptions are intended to be illustrative rather than limiting. For example, the above-described examples (or one or more embodiments thereof) may be used with reference to other examples. For example, although the exemplary scenario where WeChat Pay is used for contract signing for withholding funds in a large cruise ship is given in this description, those skilled in the art can understand that technical solutions of this disclosure may alternatively be applicable to various application scenarios where network resources are limited, such as a major sports event or a party, and a variety of other mobile payment tools may be used. For example, a person of ordinary skill in the art may use other embodiments after reviewing the foregoing descriptions. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not state each feature disclosed in this description since the embodiments can represent subsets of the feature. In addition, an embodiment may include fewer features than those disclosed in an example. Thus, the following claims are hereby incorporated into the Detailed Description, with each claim standing on its own as a separate embodiment. The scope of the invention should be determined with reference to the appended claims, along with the full scope of equivalents to which such claims are entitled.

What is claimed is:

1. A terminal for mobile payments, comprising:
a camera configured to scan an identification code generated by a payment application;
a touch-sensitive display screen configured to display a prompt to a user and receive a touch input of the user, wherein the prompt comprises a message for prompting the user to perform one or more following operations: placing the identification code within a scanning area of the camera, inputting personal identification information, and creating a signed authorization;
a processor, configured to:
transmit to a payment server a result from the camera scanning the identification code for verification;
prompt, in response to a first successful verification result received from the payment server, the user to input the personal identification information by using the touch-sensitive display screen;
receive the personal identification information inputted by the user on the touch-sensitive display screen, and transmit the personal identification information to a service provider server for verification;
prompt, in response to a second successful verification result received from the service provider server, the user to provide the signed authorization for a contract by using the touch-sensitive display screen;
receive the signed authorization from the user via the touch-sensitive display screen, and send a contract signing request to the payment server by using the signed authorization; and
receive, from the payment server, a notification indicating whether a contract signing succeeds.

2. The terminal for mobile payments according to claim 1, wherein the identification code is a two-dimensional code, a bar code, or an electronic tag.

3. The terminal for mobile payments according to claim 1, wherein the touch-sensitive display screen is further configured to display a notification indicating a successful contract signing.

4. The terminal for mobile payments according to claim 1, wherein the signed authorization is a handwritten signature of the user.

5. The terminal for mobile payments according to claim 4, wherein the terminal further comprises a stylus pen, and the handwritten signature is written on the touch-sensitive display screen by the user using the stylus pen.

6. The terminal for mobile payments according to claim 1, wherein the signing request is for withholding funds.

7. The terminal for mobile payments according to claim 1, wherein the terminal further comprises an input configured to receive a user input, and the user input comprises the personal identification information and the signed authorization from the user for the contract signing.

8. The terminal for mobile payments according to claim 7, wherein the input comprises a card reader, and the personal identification information is obtained by using the card reader to read a smart card provided to the user by a service provider associated with the service provider server.

9. A contract signing method for mobile payments, comprising:
scanning an identification code generated by a payment application;
transmitting a result of the scanning to a payment server for verification;
prompting, in response to receiving a first successful verification result from the payment server, a user to input personal identification information;
receiving the personal identification information inputted by the user, and transmitting the personal identification information to a service provider server for verification;
prompting, in response to receiving a second successful verification result from the service provider server, the user to provide a signed authorization for a contract;
receiving the signed authorization from the user, and sending a contract signing request to the payment server by using the signed authorization; and
receiving, from the payment server, a notification indicating whether the contract signing succeeds.

10. The method according to claim 9, wherein the contract is for withholding funds, and the contract signing request is a request for the withholding funds.

11. The method according to claim 9, wherein if the verification for the result of the scanning fails, the method further comprises: prompting the user to re-present the identification code generated by the payment application.

12. The method according to claim 11, wherein when prompting the user to re-present the identification code generated by the payment application, the method further comprises: displaying on a display screen a picture showing an operation process of the identification code generated by the payment application to assist the user.

13. The method according to claim 9, wherein the prompting a user to input personal identification information comprises: providing various options to the user for inputting the personal identification information, and the various options at least comprise inputting from a keyboard, or inputting by a card reader reading a card.

14. The method according to claim 9, wherein the signed authorization is a handwritten signature of the user, and the handwritten signature is inputted on a touch-sensitive display by the user using a stylus pen or a finger.

15. The method according to claim 14, wherein before the user is allowed to create a handwritten signature, the method further comprises: showing that a preset time is reached for the contract.

16. The method according to claim 9, further comprising:
incrementing, in response to receiving a failed verification result from the service provider server, a first counter by one, and comparing a count of the first counter with a first threshold value;
returning, when the count is greater than the first threshold value, to scanning the identification code generated by the payment application; and
prompting, when the count is not greater than the first threshold value, the user to input the personal identification information again.

17. The method according to claim 9, further comprising:
incrementing, in response to receiving a failed verification result from the payment server, a second counter by one, and comparing a count of the second counter with a second threshold value;
returning, when the count is greater than the second threshold value, to scanning the identification code generated by the payment application; and
prompting, when the count is not greater than the second threshold value, the user to input the signed authorization again.

18. A contract signing system for mobile payments, comprising:
a processor; and
a memory configured with computer executable instructions executable by the processor to cause the processor to perform operations comprising:
transmitting to a payment server a result of scanning an identification code generated by a payment application for verification;
prompting, in response to receiving a first successful verification result from the payment server, a user to input personal identification information;
receiving the personal identification information inputted by the user, and transmitting the personal identification information to a service provider server for verification;
prompting, in response to receiving a second successful verification result from the service provider server, the user to provide a signed authorization for a contract;
receiving the signed authorization from the user, and sending a contract signing request to the payment server by using the signed authorization; and
receiving, from the payment server, a notification indicating whether the contract signing succeeds.

19. The system according to claim 18, wherein if the verification for the result of the scanning fails, the operations further comprise: prompting the user to re-present the identification code generated by the payment application.

20. The system according to claim 19, wherein when prompting the user to re-present the identification code generated by the payment application, the operations further comprise: displaying on a display screen a picture showing an operation process of the identification code generated by the payment application to assist the user.
